(19) United States
(12) Patent Application Publication
(10) Pub. No.: US 2006/0151752 A1
(43) Pub. Date: Jul. 13, 2006

(54) Compositions and methods for reducing static charge build-up in a polymeric material

(75) Inventors: Frank P. Lochel, Simpsonville, SC (US); Christopher M. Sculthorpe, Lyman, SC (US)

Correspondence Address: DORITY & MANNING, P.A., POST OFFICE BOX 1449, GREENVILLE, SC, 29602-1449, US

(73) Assignee: Rutgers Organics

(21) Appl. No.: 11/033,442

(22) Filed: Jan. 11, 2005

(51) Int. Cl. H01B 1/12

(52) U.S. Cl. 252/500

(57) ABSTRACT

The present invention is generally directed to a polymeric material resistant to the build-up of electric charge comprising a thermoplastic polymer and an anti-stat agent, wherein the anti-stat agent comprises a phthalate diester. For example, the thermoplastic polymer can comprise PET or its analogs. In one embodiment, the anti-stat agent can comprise a meta-phthalate diester of diethylene glycol.

### BACKGROUND OF THE INVENTION

Polymeric materials comprising either natural and/or synthetic polymers can accumulate a static charge on the surface of the polymeric material. Also, products made from these polymeric materials tend to accumulate and can retain a static charge for an extended period of time.

Static charge is typically generated through frictional contact between two surfaces. The frictional contact causes one surface to lose electrons, becoming positively charged. The other surface gains electrons, becoming negatively charged. The charged surfaces are said to have a build-up of static charge.

Accumulation of a static charge can create many problems in both the manufacture and application of the polymeric materials. For instance, a static charge build-up in the polymeric material can introduce a hazardous electrical discharge in the manufacturing environment. Also, static charge build-up can add to the cost of production, packaging, and shipping of polymeric materials and product. Another disadvantage of a build-up of static charge is that the surface of polymeric materials can experience static charge built-up, resulting in the tendency of the surface to collect dust.

Polyesters and thermoplastic polymers are particularly subject to accumulation of an electric charge because they are generally poor electrical conductors. In order to help prevent a charge build-up, the equipment used in the manufacturing of the polyesters and thermoplastic polymers is typically grounded to discharge any build-up of static charge in the polyester. However, the grounding of the equipment can be costly and complicated. Additionally, the grounding of the equipment can only temporarily help solve the static charge build-up problem in the polyester, since the polymer can continue to accumulate a static charge after leaving the grounded equipment.

For example, polyesters, such as polyethylene terephthalate (PET), can be particularly subject to the build-up of a static charge in films, pellets, containers and other products. For instance, during the development of PET, a charge can develop during the extrusion step of manufacture. This charge can result in a dangerous discharge of electricity. Further, the static charge may remain in the plastic products made from PET, which can attract dust onto the products, such as plastic bottles, giving an unsightly appearance of being on the shelf for a long period. For instance, films comprising PET generally have a surface resistivity of about 10¹³ Ohms/square, indicating the build-up of a static charge in the film.

In the polyester and thermoplastic polymer industry, there have been many attempts to reduce the static charge build-up in polymeric materials. For instance, an anti-static material, or anti-stat, can be added to the surface of or incorporated into the polymeric material to reduce the build-up of a static charge. However, many current anti-stats for PET known in the art have undesirable side effects, such as yellowing or hazing of the polymeric material.

There is currently a need for an anti-stat agent which can be incorporated into a PET and can reduce or prevent the build-up of static charge without otherwise affecting the properties of the polymeric material or the products and films made with them.

### SUMMARY OF THE INVENTION

In one embodiment, the present invention is directed toward a polymeric material resistant to the build-up of electric charge comprising a thermoplastic polymer and an anti-stat agent, wherein the anti-stat agent comprises a phthalate diester. The thermoplastic polymer can comprise polyethylene terephthalate (PET) or its analogs, such as polyethylene terephthalate glycol (PETG).

The anti-stat agent of the present invention can comprise a meta-phthalate diester. For example, the anti-stat agent can comprise meta-phthalate diester of diethylene glycol. For instance, meta-phthalate diester of diethylene glycol can be added to PET in an amount from about 0.1% to about 10% by weight, such as from about 0.5% to about 2.0%.

In one aspect of this embodiment, the anti-stat can be associated with water. For instance, the anti-stat agent can be hydrated with water before the anti-stat is added to the polymeric material. For example, in one embodiment, the anti-stat agent can be hydrated by adding water in an amount of up to about 10% of the anti-stat agent, such as about 3% to about 6%. For example, the anti-stat agent can be hydrated by water in an amount of about 4.5% water by weight of the anti-stat agent.

### DETAILED DESCRIPTION OF THE INVENTION

Reference now will be made in detail to various embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention covers such modifications and variations as come within the scope of the appended claims and their equivalents.

Generally, in accordance with the present invention, an anti-stat agent is combined with a polymeric material to reduce the build-up of static charge in the polymeric material.

One embodiment of the present invention is directed toward a polymeric material and polymeric films and molded parts which are resistant to the build-up of electric charge, which can develop during or after the processing of the polymeric material whether by extrusion or by various types of molding processes or the packaging of the end polymeric products. In another embodiment, the present invention is generally directed toward processes and methods for reducing the build-up of electric charge in polymeric materials and the products made from the polymeric materials.

The amount of static charge build-up in a material can be measured by the surface resistivity of the material. Surface resistivity is a measure of the intensity of electrical current flowing over the surface of the material, quantifying the ability of the surface to conduct electricity in Ohms/square. Generally, an effective anti-static additive or coating is one that will reduce the surface resistivity of the material to which it is applied or incorporated.

According to the present invention, the build-up of static charge in the polymeric material can be reduced by combining an anti-stat agent with the polymeric material. The anti-stat agent can be combined with the host polymeric material by any means known to one skilled in the art at any time during the production of the polymeric material or during production of films, containers, or other products formed from the polymeric material.

For example, the anti-stat agent of the present invention may be applied to the surface of the polymeric material after the extrusion process by any method known in the art, such as spraying, printing, dipping or wiping. Generally, an anti-stat agent applied after the extrusion process is referred to as an external anti-stat agent. However, external anti-stat agents can be particularly susceptible to removal from the polymeric surface. Thus, external anti-stat agents are generally not well adapted for long term reduction of static charge because of the ease in which they can be removed.

Alternatively, an anti-stat agent can be integrated internally into the polymeric material matrix during the production of the polymeric material. Generally, anti-stat agents incorporated into the polymeric material before or during the extrusion process are called internal anti-stat agents. For instance, the anti-stat agent can be simply mixed into the polymeric material after the polymerization of the polymeric material is complete. In one embodiment the anti-stat agent can be incorporated into the polymeric material during the extrusion process.

The polymeric material incorporating an internal anti-stat agent can be processed into any end product that would normally be produced by the polymeric material. For example, PET incorporating an internal anti-stat agent can be made into films, pellets, fibers, containers, and any other end products normally manufactured from PET without substantially changing the properties and characteristics of the polymeric material or the products made with the polymeric material.

For example, the anti-stat agent of the present invention is substantially non-hazing to the host polymeric material. Without wishing to be bound by theory, an additive is non-hazing if the solubility of the additive is such that it does not interfere with the chemical structure or the refractive index of the extruded films or molded parts of the polymeric material. The films and molded parts of the polymeric material can remain transparent with the addition of a non-hazing additive.

Additionally, many additives to PET create an undesirable yellowing of the PET, which interferes with the clarity of the PET and the resulting PET products. However, combining an anti-stat agent to PET according to the present invention does not substantially yellow or otherwise substantially interfere with the clarity of the PET. Without wishing to be bound by theory, it is believed that to be a non-yellowing additive, the additive must be thermally stable at the extrusion and forming temperatures of the polymeric material so the additive does not chemically degrade, preventing any color formation of the additive.

Also, the anti-stat agent of the present invention can be migratory. A migratory additive is one that will migrate to the surface of the polymeric film or molded parts. If the migratory additive is removed from the surface by physical or chemical action, then the migratory additive will regenerate a new additive film on the surface of the film or molded parts. Generally, the additive will have two functional groups, one that is more soluble with the host polymeric material than the other. The less soluble component of the additive will tend to migrate toward the surface of the polymeric material, while the more soluble component of the anti-stat agent will tend to stay within the polymeric material matrix.

The rate an additive migrates can depend on a number of factors known to one skilled in the art, including the relative solubility of the additive and the polymeric material, the crystallinity of the polymeric material, and the concentration of the additive. Additionally, one skilled in the art can substantially control the migration rate of the additive by adjusting the additive's characteristics to change one of the rate factors.

According to the present invention, the polymeric material can be any plastic material that has the tendency to build-up a static charge, including but not limited to polyesters and thermoplastic polymers. For instance, the polymeric material can comprise a thermoplastic polymer, such as polyethylene terephthalate (PET).

In one embodiment, the anti-stat agent of the present invention comprises a phthalate diester formed, for example, from an isomer of phthalic acid. Phthalic acid, also called benzenedicarboxylic acid with formula C₆H₄(COOH)₂, is the name of any of three isomers. Generally, the ortho form (1,2-benzenecarboxylic acid) is simply called phthalic acid. According to the present invention, the ortho-phthalate diester anti-stat agent has a formula of 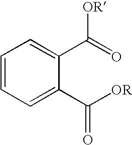
Where R=(CH₂CH₂O)ₙH, CH₃, or H. Where n is an integer between 1 and 10. And, where R′=(CH₂CH₂O)ₙH, CH₃, or H. Where n is an integer between 1 and 10.

The meta form of phthalic acid is referred to as isophthalic acid (1,3-benzenecarboxylic acid). The meta-phthalate diester anti-stat agent of the present invention has a formula of 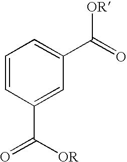
Where R=(CH₂CH₂O)ₙH, CH₃, or H. Where n is an integer between 1 and 10. And, where R′=(CH₂CH₂O)ₙH, CH₃, or H. Where n is an integer between 1 and 10.

The para form of phthalic acid is known as terephthalic acid (1,4-benzenecarboxylic acid). The para-phthalate diester anti-stat agent of the present invention has a formula of 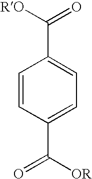
Where R=(CH₂CH₂O)ₙH, CH₃, or H. Where n is an integer between 1 and 10. And, where R′=(CH₂CH₂O)ₙH, CH₃, or H. Where n is an integer between 1 and 10.

In one embodiment, the para-phthalate diester anti-stat agent according to the above formula is combined with a polymeric material. For example, the para-phthalate diester anti-stat agent can be combined with a thermoplastic polymeric material, such as PET. However, some of the para-phthalate diesters, such as a para-phthalate diester of diethylene glycol, may be too soluble in PET to effectively migrate to the surface of the film or product, thereby decreasing the ability of the para-phthalate diester to effectively reduce the static charge build-up in the polymeric film or product.

In one particular embodiment, the anti-stat agent can comprise the meta-phthalate diester of the formula above. For instance, the meta-phthalate diester can comprise a meta-phthalate diester of diethylene glycol, produced by reacting 2 moles of diethylene glycol with 1 mole of meta-phthalic acid, having the structure:

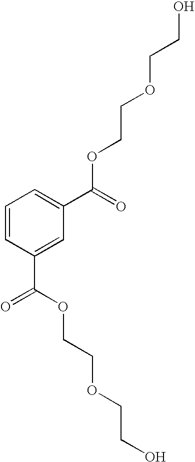

In this embodiment, the meta-phthalate diester of diethylene glycol can be combined with the polymeric material such that the anti-stat agent comprises from about 0.1% to about 10% of by weight of the polymeric material. For instance, the anti-stat agent can comprise from about 0.5% to about 2.0% of the polymeric material, such as about 1% of the polymeric material.

In one embodiment, water can be associated with the anti-stat agent by any means known to one skilled in the art. In one embodiment, the polymeric material and anti-stat agent can be combined then exposed to a humid environment, allowing water vapor to associate with the polymeric material.

The anti-stat agent can also be hydrated with water before the anti-stat agent is added to the polymeric material. Without wishing to be bound by theory, it is believed that water can hydrate the crystal of the anti-stat agent molecule. Upon this hydration, the anti-stat agent actually changes physical appearance. As such, the anti-stat agent can comprise water as part of the anti-stat agent molecule. For instance, water can comprise up to about 10% by weight of the anti-stat agent. For example, water can comprise from about 0.1% to about 10%, such as from about 3% to about 6%. In one particular embodiment, for example, the anti-stat agent can be hydrated by water in an amount such that the anti-stat agent comprises about 4.5% water by weight of the anti-stat agent.

Hydration of the anti-stat agent can be accomplished by any method know to one skilled in the art. For example, the anti-stat agent can be hydrated by simply exposing the anti-stat agent to a humid environment.

In another embodiment, water can be associated with the anti-stat agent after the anti-stat agent has been incorporated into the polymeric material. For instance, the anti-stat agent can be added to the polymeric material, then the polymeric material comprising the anti-stat agent can be molded into the final product, such as a container. Once the anti-stat agent is in the final product of the polymeric material, the anti-stat agent can migrate to the surface of the polymeric where it can attract water molecules. For example, after extruding the anti-stat agent into the polymer, the anti-stat can migrate to the surface of the polymeric material where the anti-stat agent can attract water. The anti-stat agent can also be previously hydrated prior to adding the anti-stat agent to the polymeric material.

In this embodiment, the water can be associated with the anti-stat material in a free, or easily dissociated manner. For instance, the water can be associated with the anti-stat agent in a manner allowing the water to be titrated off of the anti-stat material molecules. Without wishing to be bound by theory, it is believed that water associated with the anti-stat material can help reduce the static charge build-up because water is more conductive than the polymeric material.

The polymeric material incorporating the anti-stat agent can be formed into any end product that would typically produced from the particular polymeric material. For example, thermoplastic polymers incorporating the anti-stat agent of the present invention can be made into films or molded into any shape that is desired. For instance, PET incorporating an anti-stat agent of the present invention can be made into films, pellets, fibers, containers, bottles, and other products.

In one embodiment, the anti-stat agent can be added to the polymeric material, such as mixed into the polymeric material in its resin form. Then, the polymeric material and the anti-stat agent mixture can be extruded, such as melt-blending, into a molded form. For instance, a meta-phthalate diester of diethylene glycol can be added to PET in its resin form. Then the mixture can be extruded into a film or a molded material, such as a container.

In another embodiment, the anti-stat agent of the present invention can be compounded with the polymeric material. For instance, PET resin and an anti-stat agent, such as meta-phthalate diester of diethylene glycol, can be melt-blended together forming compounded pellets.

In another embodiment, the anti-stat agent can be added to the polymeric material during the formation of the films or molded parts and products, such as during the extrusion of the polymeric material. For instance, an anti-stat agent such as meta-phthalate diester of diethylene glycol can be added to PET during the extrusion of the PET into films or molded parts, such as containers, pellets, or the like.

In one embodiment, the anti-stat agent can be added to PET in such a concentration that a final product made from the PET anti-stat mixture, such as a film or molded part, comprises from about 0.1% to about 10% anti-stat agent by weight, such as about 0.1% to about 5%. For instance, in one embodiment, the PET anti-stat mixture can comprise from about 0.5% to about 2% anti-stat agent by weight, such as about 1%.

The final product produced from the polymeric material incorporating the anti-stat agent of the present disclosure can have a lower surface resistivity than that of the polymeric material without the anti-stat agent present. For example, PET normally has a surface resistivity of about 10¹³ Ohms/sq. However, when PET is mixed with an anti-stat agent according to the present disclosure, the resulting PET and anti-stat agent material can have a surface resistivity of less than about 10¹³ Ohms/sq, such as less than about 10¹² Ohms/sq. For instance, in one embodiment, the PET and anti-stat agent material can have a surface resistivity of less than about 10¹¹ Ohms/sq.

### EXAMPLE

An anti-stat agent comprising a meta-phthalate diester of diethylene glycol was prepared according to the following method: reacting 1.0 moles of m-phthalic acid, 2.16 moles of diethylene glycol, and a catalytic amount of methane sulfonic acid (about 0.1% by weight). The reaction was carried out at −190° C. for 200 minutes. The meta-phthalate diester of diethylene glycol was hydrated to contain about 4.5% water by weight.

A polymeric material incorporating an anti-stat agent was formed by combining and mixing PET and meta-phthalate diester of diethylene glycol at 1% by weight of the PET. Then, the polymeric material was extruded into a film.

The resulting polymeric film's surface resistivity (measured in Ohms/sq) was compared to that of a film of PET without an anti-stat agent, as shown in Table 1. The surface resistivity measurements were conducted by a Resistance/Current Meter, Model 278 sold by Electro-Tech Systems, Inc. of Glenside, Pa.

| | Initial | 3 Day | 21 Day | 60 Day | 90 Day | 120 Day | 180 Day |
|---|---|---|---|---|---|---|---|
| Polymeric | surface | surface | surface | surface | surface | surface | surface |
| Material | resistivity | resistivity | resistivity | resistivity | resistivity | resistivity | resistivity |
| PET | 10¹³ | 10¹³ | 10¹³ | 10¹³ | 10¹³ | 10¹³ | 10¹³ |
| PET and anti- | 10¹¹ | 10¹¹ | 10¹¹ | 10¹¹ | 10¹² | 10¹² | 10¹² |
| stat agent | | | | | | | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A polymeric material resistant to the build-up of electric charge comprising:
a thermoplastic polymer, and
an anti-stat agent, wherein said anti-stat agent comprises a phthalate diester.

2. The polymeric material of claim 1, wherein the thermoplastic polymer comprises polyethylene terephthalate.

3. The polymeric material of claim 2, wherein the polymeric material has an initial surface resistivity of less than about 10¹² Ohms/sq.

4. The polymeric material of claim 2, wherein the polymeric material has an initial surface resistivity of less than about 10¹¹ Ohms/sq.

5. The polymeric material of claim 1, wherein the anti-stat agent is hydrated with water.

6. The polymeric material of claim 5, wherein said anti-stat agent is hydrated so as to contain about 0.1% to about 10% water by weight.

7. The polymeric material of claim 1, wherein the phthalate diester comprises a meta-phthalate diester of the formula: 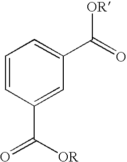
wherein R=(CH₂CH₂O)ₙH, CH₃, or H, and n is an integer between 1 and 10; and wherein R′=(CH₂CH₂O)ₙH, CH₃, or H, and n is an integer between 1 and 10.

8. The polymeric material of claim 7, wherein the meta-phthalate diester comprises a meta-phthalate diester of diethylene glycol of the formula:

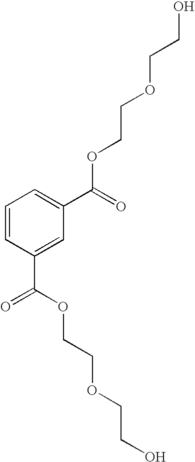

9. The polymeric material of claim 8 wherein the meta-phthalate diester of diethylene glycol is hydrated so as to contain about 0.1% to about 10% water by weight.

10. The polymeric material of claim 9 wherein the meta-phthalate diester of diethylene glycol is hydrated so as to contain about 3% to about 6% water by weight.

11. The polymeric material of claim 1, wherein the polymeric material is molded into a final product.

12. The polymeric material of claim 11, wherein the anti-stat agent comprises from about 0.1% to about 10% by weight of the final molded product.

13. The polymeric material of claim 1, wherein the polymeric material is melt-blended together.

14. The polymeric material of claim 1, wherein the polymeric material is a film.

15. The polymeric material of claim 1, wherein the polymeric material is a container.

16. The polymeric material of claim 1, wherein the polymeric material is a pellet.

17. The polymeric material of claim 1, wherein the polymeric material is a fiber.

18. A polymeric material resistant to the build-up of electric charge comprising:
polyethylene terephthalate, and
a meta-phthalate diester of the formula: 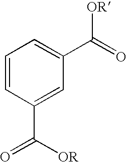
wherein R=(CH₂CH₂O)ₙH, CH₃, or H, and n is an integer between 1 and 10; and wherein R′=(CH₂CH₂O)ₙH, CH₃, or H, and n is an integer between 1 and 10; and
wherein said meta-phthalate diester comprises from about 0.1% to about 10% by weight of the polymeric material.

19. The polymeric material of claim 18, wherein said meta-phthalate diester is hydrated with water in an amount so as to contain about 0.1% to about 10% by weight.

20. The polymeric material of claim 19, wherein said meta-phthalate diester is hydrated with water in an amount so as to contain about 3% to about 6% by weight.

21. The polymeric material of claim 19, wherein said meta-phthalate diester is hydrated with water in an amount so as to contain about 4.5% by weight.

22. The polymeric material of claim 19, wherein said meta-phthalate diester comprises a meta-phthalate diester of diethylene glycol of the formula:

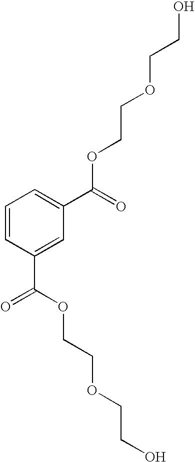

23. The polymeric material of claim 19, wherein the polymeric material is melt-blended together.

24. A method for reducing static charge build-up in a polymeric material, comprising:
providing an anti-stat agent comprising meta-phthalate diester of the formula: 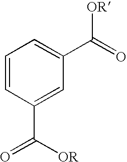
wherein R=(CH₂CH₂O)ₙH, CH₃, or H, and n is an integer between 1 and 10; and wherein R′=(CH₂CH₂O)ₙH, CH₃, or H, and n is an integer between 1 and 10;
hydrating the anti-stat agent with water; and
combining the anti-stat agent with a polymeric material.

25. The method of claim 24, wherein the polymeric material comprises polyethylene terephthalate.

26. The method of claim 25, wherein the meta-phthalate diester comprises a meta-phthalate diester of diethylene glycol of the formula:

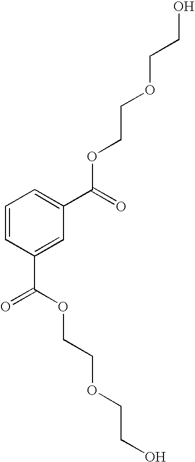

27. The method of claim 26, wherein the meta-phthalate diester of diethylene glycol comprises between about 0.1% to about 10% of the polymeric material by weight.

28. The method of claim 26, wherein the meta-phthalate diester of diethylene glycol comprises between about 0.5% to about 2% of the polymeric material by weight.

29. The method of claim 26, wherein the anti-stat agent is hydrated in an amount so as to contain about 0.1% to about 10% water by weight.

30. The method of claim 26, wherein the anti-stat agent is hydrated in an amount so as to contain about 3% to about 6% water by weight.

31. The method of claim 26, wherein the anti-stat agent is hydrated in an amount so as to contain about 4.5% water by weight.
